(19) United States
(12) Patent Application Publication
(10) Pub. No.: US 2026/0005358 A1
(43) Pub. Date: Jan. 1, 2026

(54) ADJUSTABLY WEIGHTED BATTERY TRAY

(71) Applicant: Ryan Westcott, Queen Creek, AZ (US)

(72) Inventor: Ryan Westcott, Queen Creek, AZ (US)

(21) Appl. No.: 18/793,759

(22) Filed: Aug. 3, 2024

Related U.S. Application Data
(60) Provisional application No. 63/665,361, filed on Jun. 28, 2024.

(51) Int. Cl. H01M 50/233; H01M 50/224; H01M 50/227; H01M 50/231; H01M 50/249

(52) U.S. Cl. CPC H01M 50/233; H01M 50/224; H01M 50/227; H01M 50/231; H01M 50/249; H01M 2220/20

(57) ABSTRACT

An adjustably weighted battery tray for marine craft including an interior chamber that is adapted to allow a user to add and adjust the amount of weight added to the adjustably weighted battery tray. As such, the user can employ and attach a lithium ion battery, which is lighter than traditional lead acid batteries, to the adjustably weighted battery tray and then match the weight of a traditional lead acid battery by inserting additional weight into the adjustably weighted battery tray to thereby maintain the battery weight within the stern section of the marine craft to which the marine craft was designed for, and thereby maintain the efficiency, performance, and top end speed of the marine craft.

### BACKGROUND OF THE INVENTION

### 1. Field of the Invention

This invention relates generally to battery trays, and more specifically to battery trays for marine craft.

### 2. Description of the Related Art

Prior art marine battery trays are design for lead acid batteries to be attached thereto. The problem is that lithium ion batteries are now being employed within marine craft, however the weight of lithium ion batteries are less than the weight of lead acid batteries. As such the weight of the lithium ion batteries attached to the prior art marine craft battery trays and placed within the stern section of a marine craft is much less, and as such effects the overall efficiency, performance, and top end speed of the marine craft.

Historically bass boats store three, four, or even five AGM or lead acid batteries in the rear of the boat to power all the necessary electronics. A trolling motor, well pumps, bilge pumps, chart plotters, GPS graphs, and even a stereo systems is run off of batteries after the engine is turned off. In order to get better performance out of your batteries anglers have gone to using lithium ion batteries to get longer running times for all electronic components in the vessel. The advantages of running lithium batteries include longer amp hours and runtimes per battery. The disadvantages include losing the extra battery weight from the lead acid or AGM battery in the stern section of the boat, which ultimately affects the top end in speed of the boat. Anglers have attempted to solve this issue with adding weighted ballast bags in the rear which can be dangerous since they are just placed in the stern section of the boat loosely. If a heavy weighted bag moves around from rough waters and causes wires on the battery terminals to come loose and arc a fire can erupt in the stern section and cause catastrophic failure of the vessel. Anglers have also purchased new propellers with different pitches to try and regain the top end speed lost from the weight reduction which is a very costly venture when propellers can range in price from $600-$5000.

Therefore, a need exists for an adjustably weighted battery tray for marine craft to avoid the above-mentioned problems.

### BRIEF SUMMARY OF THE INVENTION

In view of the foregoing disadvantages inherent in the known types of marine craft battery trays or the like in the prior art, the present invention provides a novel adjustably weighted battery tray for marine craft. As such, the general purpose of the present invention, which will be described subsequently in greater detail, is to provide an adjustably weighted battery tray for marine craft including an interior chamber that is adapted to allow a user to add and adjust the amount of weight added to the adjustably weighted battery tray. As such, the user can employ and attach a lithium ion battery, which is lighter than traditional lead acid batteries, to the adjustably weighted battery tray and then match the weight of a traditional lead acid battery by inserting additional weight into the adjustably weighted battery tray to thereby maintain the battery weight within the stern section of the marine craft to which the marine craft was designed for, and thereby maintain the efficiency, performance, and top end speed of the marine craft, with all the advantages of the prior art and none of the disadvantages.

There has thus been outlined, rather broadly, the more important features of the invention in order that the detailed description thereof that follows may be better understood and in order that the present contribution to the art may be better appreciated. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, an adjustably weighted battery tray, constructed and operative according to the teachings of the present invention.

FIG. 1 shows a front perspective interior view of the adjustably weighted battery tray without additional weights according to the preferred embodiment of the present invention.

FIG. 2 shows a front perspective view illustrating the adjustably weighted battery tray with additional weights installed according to the preferred embodiment of the present invention of FIG. 1.

FIG. 3 shows a front perspective view illustrating the adjustably weighted battery tray with additional weights installed and a lithium ion battery on top according to the preferred embodiment of the present invention of FIG. 1.

FIG. 4 shows a side perspective view illustrating the adjustably weighted battery tray installed within a boat's stern section according to the preferred embodiment of the present invention of FIG. 1

The various embodiments of the present invention will hereinafter be described in conjunction with the appended drawings.

### DETAILED DESCRIPTION

As discussed above, embodiments of the present invention relate to an adjustably weighted battery tray.

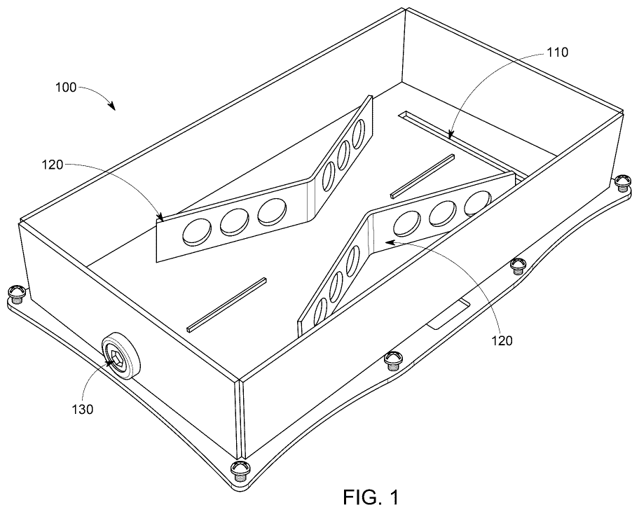

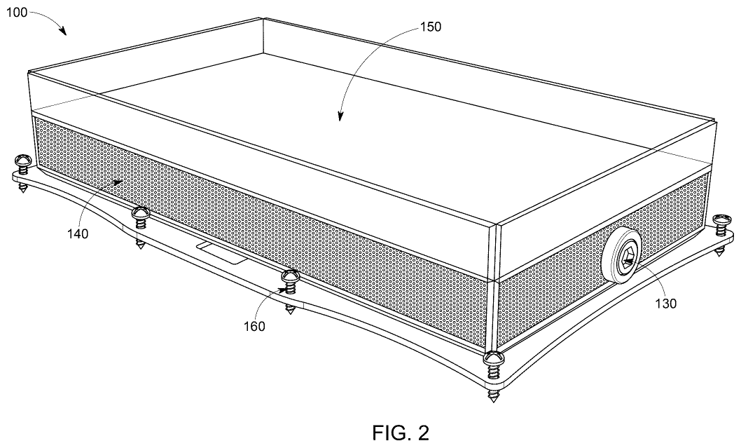

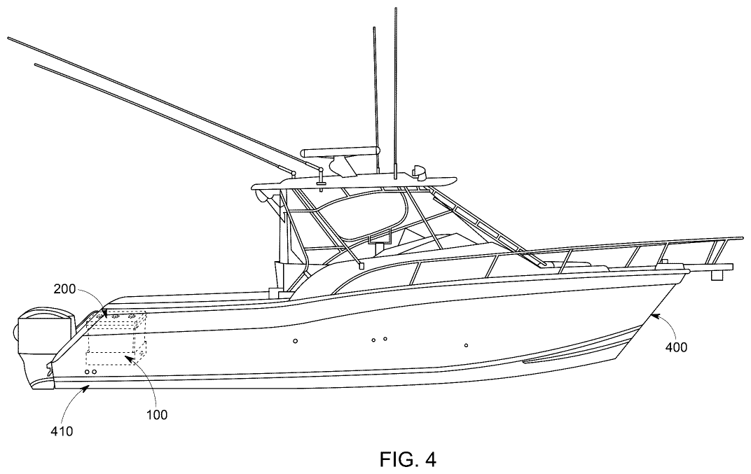

Referring now to FIGS. 1-4, the adjustably weighted battery tray 100 includes a bottom wall, side walls, and a top wall forming an interior chamber 110 that allows a user to add and remove weights 140 to the adjustably weighted battery tray. One of the side walls includes a removable plug 130 adapted to allow weights 140 to be installed into and removed from interior chamber 110. Baffles 120 are attached to the bottom interior floor to prevent the additional weights from moving around during use. As such, a user can employ and attach a lithium ion battery 200, which is lighter than traditional lead acid batteries, to the adjustably weighted battery tray and thereby match the weight of the traditional lead acid battery to thereby maintain the overall battery weight within the stern section 410 of a marine craft 400 to which the marine craft was designed for, and thereby maintain the efficiency, performance, and top end speed of the marine craft.

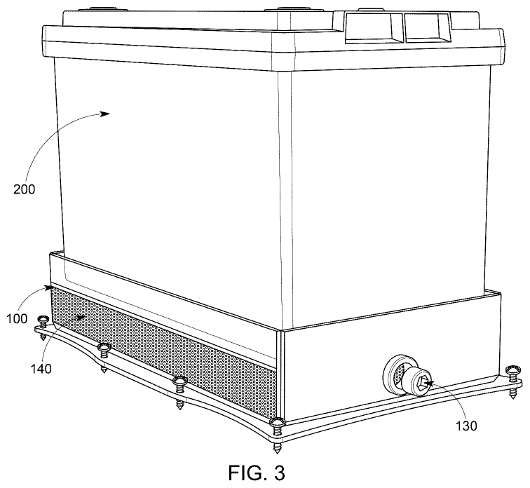

Baffles 120 can be formed having a bend therein thereby forming a V-shape which further reduces movement of the additional weights within the interior chamber during use. Furthermore, the top wall can be attached to the plurality of side walls at mid-portions thereof thereby forming an upper tray section 150 adapted to securely hold the battery thereon, as shown in FIG. 3.

When in use, a user would measure the weight of the original battery that the marine craft 400 was designed for, then measure the weight of the lithium battery member being installed, then insert an amount of weight 140 into interior chamber 110 that is equal to the difference of weight between the original battery and the lithium battery.

The adjustably weighted battery tray 100 may be formed from marine-grade 316 stainless steel that is fully “tig” welded with a raw finish or powder coated finish. The adjustably weighted battery tray 100 may also be formed from cold rolled steel coated with thermoplastic polyurethane and polyurea (impact rubberized bed coating) for ultimate protection and corrosion resistance.

The battery tray chamber 110 allows a user to adjust the amount of weight 140 added to the tray. The internal space of the chamber 110 may be formed 7.00″×13.00″×1.25″, such that the user can add up to 46.52 pounds using lead shot or 32.30 pounds using steel shot. Using the instant design the adjustably weighted battery tray 100 only raises the overall height by 1.125″ compared to prior art battery trays. This design is crucial to ensure fitment in all bass boats as the rear compartment is very small and has very little headroom over the top of the batteries.

The adjustably weighted battery tray 100 can usually be securely mounted with 8 screws 160 within the stern section 410 of a marine craft 400. In use, the user can weigh the old lead acid or AGM batteries of their vessel and then weigh the replacement lithium batteries to find out the difference in weight between them. The user would then add the appropriate weight to the battery tray chamber 110 to maintain the top end speed and performance of the vessel.

The adjustably weighted battery tray 100 may also incorporate a nylon strap to ensure the battery does not come loose during marine craft operation or rough water traveling.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

What is claimed is:

1. An adjustably weighted battery tray comprising:
a bottom wall;
a plurality of side walls; and
a top wall;
wherein said bottom wall, said plurality of side walls, and said top wall form an interior chamber adapted to receive weights therein to allow a user to adjust the weight of said battery tray; and
wherein one of said plurality of side walls includes:
a removable plug;
wherein said removable plug is adapted to allow weights to be installed into and be removed from said interior chamber.

2. The adjustably weighted battery tray of claim 1, further comprising:
at least one baffle;
wherein said at least one baffle is attached to said bottom wall and extends into said interior chamber, and is adapted to reduce movement of said weights within said interior chamber during use.

3. The adjustably weighted battery tray of claim 2, wherein there are two baffles attached to said bottom wall, are spaced from one another, and wherein each said baffle is adapted to reduce movement of said weights within said interior chamber during use.

4. The adjustably weighted battery tray of claim 2, wherein each of said two baffles are formed having a bend therein thereby forming a V-shape.

5. The adjustably weighted battery tray of claim 2, wherein said top wall is attached to said plurality of side walls at mid-portions thereof thereby forming an upper tray section adapted to securely hold a battery thereon.

6. The adjustably weighted battery tray of claim 1, further comprising a plurality of weights.

7. The adjustably weighted battery tray of claim 6, wherein said plurality of weights are formed a type of weights chosen from a list of weights consisting of lead shot and steel shot.

8. The adjustably weighted battery tray of claim 1, wherein said battery tray is formed from cold rolled steel coated with thermoplastic polyurethane and polyurea.

9. The adjustably weighted battery tray of claim 1, wherein said battery tray is formed having a rectangular shape and volume.

10. A combination of a marine craft and an adjustably weighted battery tray comprising:
a marine craft including:
a stern section; and
an adjustably weighted battery tray comprising:
a bottom wall;
a plurality of side walls; and
a top wall;
wherein said bottom wall, said plurality of side walls, and said top wall form an interior chamber adapted to receive weights therein to allow a user to adjust the weight of said battery tray; and
wherein one of said plurality of side walls includes:
a removable plug;
wherein said removable plug is adapted to allow weights to be installed into and be removed from said interior chamber;
wherein said adjustably weighted battery tray is adapted to be securely installed within said stern section of said marine craft.

11. The combination of claim 10, further comprising:
at least one baffle;
wherein said at least one baffle is attached to said bottom wall and extends into said interior chamber, and is adapted to reduce movement of said weights within said interior chamber during use.

12. The combination of claim 11, wherein there are two baffles attached to said bottom wall, are spaced from one another, and wherein each said baffle is adapted to reduce movement of said weights within said interior chamber during use.

13. The combination of claim 11, wherein each of said two baffles are formed having a bend therein thereby forming a V-shape.

14. The combination of claim 11, wherein said top wall is attached to said plurality of side walls at mid-portions thereof thereby forming an upper tray section adapted to securely hold a battery thereon.

15. The combination of claim 10, further comprising a plurality of weights.

16. The combination of claim 15, wherein said plurality of weights are formed a type of weights chosen from a list of weights consisting of lead shot and steel shot.

17. The combination of claim 10, wherein said battery tray is formed from cold rolled steel coated with thermoplastic polyurethane and polyurea.

18. The combination of claim 10, wherein said battery tray is formed having a rectangular shape and volume.

19. The combination of claim 10, further comprising a battery adapted to be securely placed upon said adjustably weighted battery tray when said adjustably weighted battery tray is installed within said stern section of said marine craft.

20. The combination of claim 19, wherein said battery is formed as a lithium ion battery.
